(19) United States
(12) Patent Application Publication
(10) Pub. No.: US 2003/0007040 A1
(43) Pub. Date: Jan. 9, 2003

(54) Large volume ink supply system

(75) Inventors: John C. Love, San Diego, CA (US); Peter J. Fellingham, San Diego, CA (US)

Correspondence Address: Patent Legal Staff, Eastman Kodak Company, 343 State Street, Rochester, NY, 14650-2201, US

(73) Assignee: Eastman Kodak Company

(21) Appl. No.: 10/162,332

(22) Filed: Jun. 4, 2002

Related U.S. Application Data
(60) Provisional application No. 60/302,827, filed on Jul. 3, 2001.

(51) Int. Cl. B41J 2/175

(52) U.S. Cl. 347/85

(57) ABSTRACT

An ink delivery system and method for continuously replenishing ink to a printhead cartridge is described. A primary ink reservoir is connected to a vented intermediate tank using a hollow needle that pierces a septum in the primary ink reservoir. The intermediate ink tank is connected via tubing to a print ink container in the printhead cartridge. Ink is gravity fed from the primary ink reservoir to the intermediate ink tank. When the primary reservoir is empty, the ink level in the intermediate tank will drop. The level of ink in the intermediate tank is monitored with level sensors that provide a signal indicating when the primary reservoir needs to be replaced. An operator can replace the primary reservoir without suspending printer operations because the intermediate ink tank provides the required volume of ink at the back pressure needed by the printhead cartridges.

### CROSS REFERENCE TO RELATED APPLICATIONS

Reference is made to and priority claimed from U.S. Provisional Application Serial No. 60/302,827, filed Jul. 3, 2001, entitled LARGE VOLUME INK SUPPLY SYSTEM.

### FIELD OF THE INVENTION

The present invention relates to ink jet printers, and more specifically to an ink supply system for an inkjet printer.

### BACKGROUND OF THE INVENTION

Inkjet type printers typically employ a print head/cartridge which is moved in a transverse fashion across a print media. Contemporary disposable ink jet print cartridges typically include a self-contained ink reservoir, a jet plate assembly supporting a plurality of ink jet nozzles in combination with the ink reservoir, and a plurality of external electrical contacts for connecting the ink jet nozzles to driver circuitry.

Different types of ink jet printers form their droplets of ink employing different methods. There are several technologies used by printer manufacturers, with one popular technique being thermal jet. In a thermal jet printer, resistors create heat which vaporizes ink to create a bubble within a print nozzle. The expansion causes the nozzle to eject a droplet of ink onto the media. For a printer of this type there may be hundreds of these nozzles on the print head. Print head failure is usually due to failure of the resistors used to heat the ink in proximity to each nozzle. Due to relatively low resistor failure rates, the print head assemblies used in the currently available disposable ink jet cartridges are fully suitable for continued printing even after the original ink reservoir has been depleted.

Thus, one problem which can exist with ink jet printers of this type is that the ink jet cartridges are quickly depleted of their relatively small quantities of ink. The disposal of these ink jet cartridges which are still able to perform adequately, except for the lack of ink in their supply containers, is wasteful. As a result, it is known in the art to manually replenish the ink reservoir within the disposable ink jet cartridge. However, manually refilling the disposable printhead cartridges is often messy and difficult because many disposable ink jet cartridges are not designed with refilling in mind.

Other conventional printers include replaceable ink tanks containing larger reservoirs of ink which are located external to the ink jet cartridges. The external ink reservoirs are connected respectively to the ink supply reservoirs inside the ink jet cartridges in such a manner that ink is fed to the supply containers of the cartridges as ink is ejected.

Typical printer designs don't allow for replacement of large volume ink tanks during printing because the external ink supply reservoir is responsible for closing the system to maintain back pressure in the print cartridge while keeping a supply of ink flowing to the cartridge. In these systems, printing operations must be suspended when the tank is replaced. This can cause irregularities on the print media if the ink reservoir runs out of ink during the middle of a print job, requiring the need to scrap the print media and start over.

### SUMMARY OF THE INVENTION

In one embodiment, the invention includes an ink delivery system for continuously supplying ink to an ink jet printer. The ink delivery system includes a primary ink reservoir having a box-like housing defining an interior cavity, and a sealed collapsible bag for holding a supply of ink, wherein the collapsible bag comprises a septum at a connection portion of the bag, wherein the collapsible bag is positioned in the interior cavity of the housing such that a portion of the top of the collapsible bag remains at a substantially constant level. The system further includes an intermediate ink tank, and a first ink path connected between the primary ink reservoir and the intermediate ink tank for conveying ink between the primary ink reservoir and the intermediate ink tank. The first ink path has a hollow needle and an a valve, wherein the needle is configured to removably pierce the septum in the collapsible bag to provide an ink flow path from the primary ink reservoir to the intermediate ink tank. The system also includes a printhead cartridge and a second ink path connected between the intermediate ink tank and the printhead cartridge for conveying ink between the intermediate ink tank and the printhead cartridge.

In another embodiment, the invention also includes a method of replacing an ink reservoir while ink is being expelled from nozzles of an ink jet cartridge. The method includes routing ink from a sealed collapsible bag to a vented ink tank by inserting a hollow needle which is fluidly connected to the vented ink tank through a septum in the collapsible bag; routing ink from said vented ink tank to a printhead cartridge, allowing ink to flow from the intermediate tank to a printhead cartridge to replace ink used during printer operations and replacing the collapsible bag when the collapsible bag is substantially empty of ink by removing the hollow needle from the septum in the substantially empty collapsible bag and inserting the needle through a septum of a full collapsible bag. In another embodiment, the invention also includes monitoring the ink level in the intermediate tank with a fluid level sensor.

Another embodiment of the invention is a method of continuously supplying ink to an ink jet printer during printer operations such that printer operations are not suspended during replenishment of the ink supply. The method includes routing ink from a sealed collapsible bag to a vented ink tank and routing ink from said vented ink tank to a printhead cartridge.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a schematic diagram of an ink supply system with a bag-in-box reservoir, an intermediate tank and a printhead cartridge according to one embodiment of the invention.

### DETAILED DESCRIPTION OF THE INVENTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

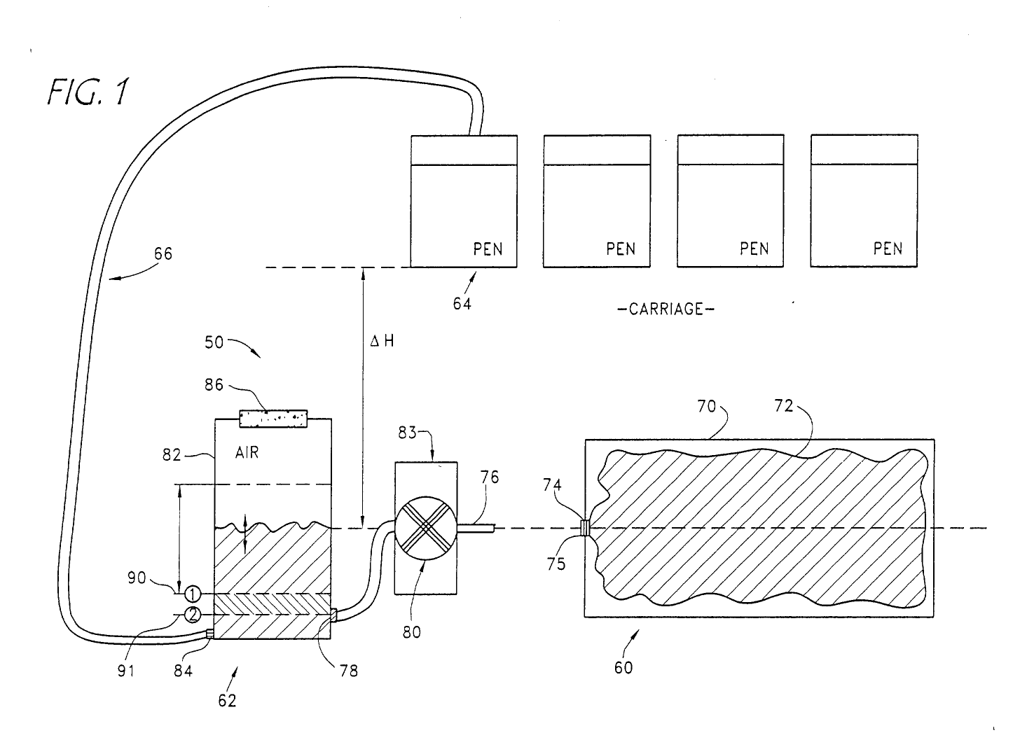

Referring to FIG. 1, one embodiment of an ink supply system 50 in accordance with principles of the invention includes a primary, replaceable ink reservoir, also referred to as a bag-in-box reservoir 60, an intermediate ink tank 62, and a refillable printhead cartridge 64. The printhead cartridge 64 is typically mounted on a moving print carriage (not shown) and ejects ink onto a print media. An ink tube 66 connects the intermediate ink tank 62 to the printhead cartridge 64 so as to transfer ink from the intermediate ink tank 62 to the printhead cartridge 64. It will be appreciated that a four color printer has four printhead cartridges 64 and four sets of primary ink reservoirs and intermediate ink tanks, only one set of which is shown for clarity.

In one embodiment, the bag-in-box reservoir 60 includes a rigid, box-shaped housing 70 with a sealed, collapsible bag 72 inside the housing 70. Alternately, the housing 70 can be other shapes, such as a cylinder or the like. The housing 70 configured so that the interior of the housing is open to the atmosphere. The collapsible bag 72 resides inside the housing 70 and is filled with ink. Preferably, the collapsible bag 72 is filled only with ink such that it is substantially free of entrapped air. The collapsible bag 72 includes a fluid connection 74 for coupling the collapsible bag 72 with the intermediate ink tank 62. As will be explained below, ink is routed from the fluid connection 74 in the collapsible bag 72 through an interface module 83 to the intermediate ink tank 62.

In one embodiment, the fluid connection 74 is a self-sealing septum 75 as are commonly used in the field. The septum 75 is used to interface the collapsible bag 72 with a hollow needle 76 attached to the interface module 83. When the needle 76 is inserted through the septum 75, ink can flow from the collapsible bag 72 through the needle 76 to the intermediate tank 62. When the needle is removed from the septum 75, the septum 75 seals itself such that ink will not leak or drip from the collapsible bag 72.

A mechanically actuated valve 80 in the interface module 83 is located between the needle 76 and an inlet port 78 of the intermediate ink tank 62. The valve 80 controls the flow of ink through the needle 76. In one embodiment, when the needle 76 is inserted through the septum 75, the valve 80 automatically opens thereby allowing ink to flow from the collapsible bag 72 to the intermediate ink tank 62. When the needle 76 is removed from the septum 75, the valve 80 automatically shuts, substantially preventing ink from draining from the intermediate ink tank 62 back through the needle 76. As a variety of self-actuating valves of this type are commercially available, further details about the valve 80 will not be provided.

In one embodiment, the intermediate ink tank 62 is mounted to the printer and includes a housing 82 having the inlet port 78 and an outlet port 84. In one embodiment, the intermediate tank is positioned such that during printing operations, the intermediate ink tank 62 contains a volume of ink and a volume of air. The intermediate ink tank 62 is vented to the atmosphere via a vent valve 86. The vent valve 86 permits the passage of air, but substantially prevents the passage of fluid. Thus, the intermediate tank 62 is vented to the atmosphere, but ink cannot escape the intermediate ink tank 62 through the vent valve 86. Additionally, the vent valve 86 prevents ink from spilling from the intermediate tank 62 during shipping or movement of the printer. The ink tube 66 connects the outlet 84 to the printhead cartridge 64, or any other device requiring ink delivery.

The intermediate ink tank 62 and the bag-in-box reservoir 60 are mounted such that the placement of the fluid connection 74 of the collapsible bag 72 corresponds to a desirable level of ink in the intermediate ink tank 62 during normal printing operation. One skilled in the art will understand that the height difference ΔH between the level of the ink in the intermediate ink tank 62 and the jet plate on the bottom surface of the cartridge 64 determines the back pressure in the printhead cartridge 64.

In one embodiment, the placement of the intermediate tank 62 is such that the volume of air in the intermediate tank 62 is sufficient to accommodate a volume of ink contained in the ink tube 66 in the event the ink tubing 66 should de-prime and drain back into the intermediate tank 62. In another embodiment, the air volume is designed to be substantially zero, relying on the vent valve 86 to block fluid flow and not allow the ink in the ink tube 66 to drain out in the event that the ink tube 66 looses its prime.

During printing operations, as the printhead cartridge 64 ejects ink onto the print media, ink flows from the intermediate tank 62 to the printhead cartridge 64 through the ink tube 66. As the ink level in the intermediate tank 62 lowers, ink flows from the collapsible bag 72 to the intermediate ink tank 62, thereby maintaining the level of ink in the intermediate ink tank 62. Thus, the bag-in-box reservoir 60 constantly replenishes the ink in the printhead cartridge 64 via the intermediate ink tank 62 during printing operations. An operator only needs to replace the bag-in-box reservoir 60 in order to replenish the ink supply of the printhead cartridge 64, eliminating any need to pour ink into an ink reservoir or manually refill the printhead cartridge 64.

Because the intermediate ink tank 62 provides the necessary cartridge back pressure, the bag-in-box reservoir 60 can be changed during printing operations without affecting the pressure in the printhead cartridge 64 or disrupting the print operations. When the needle 76 is removed from the septum 75 to remove the bag-in-box reservoir 60, the valve 80 closes and the intermediate ink tank 62 performs as a stand-alone reservoir for the printhead cartridge 64. As printing continues, the level of ink in the intermediate reservoir 62 will lower. However, the volume of ink in the intermediate ink tank 62 provides a buffer of time during which the bag-in-box reservoir 60 can be replaced. When the bag-inbox reservoir 60 is replaced and the needle 76 is inserted in the septum 75, valve 80 opens and the level of ink in the intermediate ink tank 62 returns to the level corresponding to the level of the fluid connection 74 of the collapsible bag 72.

In one embodiment, the intermediate ink tank 62 has a level sensing system to determine when the collapsible bag 72 is empty. The housing 82 has first and second fluid level sensors 90 and 91 located below the normal operating fluid level in the intermediate ink tank 62 but above the fluid outlet port 84. When the volume of ink in the collapsible bag 72 is depleted, the level of ink in the intermediate ink tank 62 lowers below the level of the fluid connection 74. When the level of ink in the tank 62 reaches the first fluid level sensor 90, the sensor 90 alerts the user (via firmware, for example) that a new bag-in-box reservoir 60 must be inserted within a certain time duration.

In the event the bag-in-box reservoir 60 is exhausted of its ink supply and is not replaced, the ink level of the intermediate tank 62 will eventually reach the second fluid level sensor 91. The second fluid level sensor 91 may cause the printer to suspend printing operations until a new bag-in-box reservoir 60 is inserted and the ink level in the intermediate ink tank 62 rises above a certain level, such as the level of the first fluid level sensor 90. The suspension of printing is enacted to maintain the ink level in the intermediate ink tank 62 above the fluid outlet 84 so as to discourage the introduction of air into the ink tube 66.

The bag-in-box ink system provides a clean method of replenishing ink in the printhead cartridges 64. Also, using this “on the fly” replacement system, a user can replenish the ink supply without having to suspend printing operations. In addition, the intermediate ink tank 62 enables the use of the entire contents of the collapsible bag 72 without decreased print quality caused by unstable pressures as a result of running out of ink during printing operations.

Specific parts, shapes, materials, functions and modules have been set forth, herein. However, a skilled technologist will realize that there are many ways to fabricate the system of one embodiment of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the components illustrated may be made by those skilled in the art, without departing from the spirit or essential characteristics of the invention.

What is claimed is:

1. An ink delivery system for continuously supplying ink to an ink jet printer, the ink delivery system comprising:
a primary ink reservoir comprising:
a housing defining an interior cavity;
a sealed collapsible bag for holding a supply of ink, wherein the collapsible bag comprises a septum at a connection portion of the bag, wherein the collapsible bag is positioned in the interior cavity of the housing such that a portion of the top of the collapsible bag remains at a substantially constant level;
an intermediate ink tank;
a first ink path connected between the primary ink reservoir and the intermediate ink tank for conveying ink between the primary ink reservoir and the intermediate ink tank, the first ink path comprising a hollow needle and a valve, wherein the needle is configured to removably pierce the septum in the collapsible bag to provide an ink flow path from the primary ink reservoir to the intermediate ink tank;
a printhead cartridge; and
a second ink path connected between the intermediate ink tank and the printhead cartridge for conveying ink between the intermediate ink tank and the printhead cartridge.

2. The ink delivery system of claim 1, wherein when the needle pierces the septum, the valve automatically opens enabling ink to flow from the collapsible bag to the intermediate ink tank through said first ink path, and when the needle is removed from the septum, the valve automatically shuts.

3. The ink delivery system of claim 1, wherein the intermediate ink tank comprises a vent valve that vents the intermediate ink tank to atmospheric pressure.

4. The ink delivery system of claim 2, wherein the vent valve allows the passage of air, but prevents the passage of ink.

5. The ink delivery system of claim 1, wherein the septum is a self-sealing septum, such that when the needle is removed, leakage of ink through the septum is substantially prevented.

6. The ink delivery system of claim 1, wherein the collapsible bag is substantially free of air.

7. The ink delivery system of claim 1, wherein ink is gravity fed from the primary reservoir to the intermediate ink tank.

8. An ink delivery system for supplying ink to an ink jet printer, the ink delivery system comprising:
a primary ink reservoir comprising a sealed bag for holding a supply of ink;
a vented intermediate ink tank;
a first ink path coupling the primary ink reservoir to the intermediate ink tank;
a printhead cartridge; and
a second ink path coupling the intermediate ink tank and the printhead cartridge.

9. The ink delivery system of claim 8, wherein the sealed bag has a connection portion comprising a self-sealing septum.

10. The ink delivery system of claim 9, wherein the first ink path comprises a hollow needle and an a valve, wherein the needle is configured to pierce the septum in the collapsible bag so as to enable ink to flow from the sealed bag to the intermediate ink tank.

11. The ink delivery system of claim 8, wherein the intermediate ink tank comprises a vent valve that vents the intermediate ink tank to atmospheric pressure.

12. The ink delivery system of claim 11, wherein the vent valve allows the passage of air, but prevents the passage of ink.

13. The ink delivery system of claim 8, wherein the septum is a self-sealing septum, such that when the needle is removed, leakage of ink through the septum is substantially prevented.

14. The ink delivery system of claim 8, wherein the primary reservoir is at ambient atmospheric pressure.

15. A method of replacing an ink reservoir while ink is being expelled from nozzles of an ink jet cartridge, the method comprising:
routing ink from a sealed collapsible bag to a vented ink tank by inserting a hollow needle which is fluidly connected to the vented ink tank through a septum in the collapsible bag;
routing ink from said vented ink tank to a printhead cartridge;
allowing ink to flow from the intermediate tank to a printhead cartridge to replace ink used during printer operations;
disconnecting the substantially empty collapsible bag from the vented ink tank;
connecting a full collapsible bag by inserting the needle into the full collapsible bag; and
continuing to rout ink from said vented ink tank to said printhead cartridge.

16. The method of claim 15, further including monitoring the ink level in the intermediate tank with a fluid level sensor.

17. The method of claim 15, wherein the septum is a self-sealing septum.

18. A method of continuously supplying ink to an ink jet printer during printer operations such that printer operations need not be suspended during replenishment of the ink supply, the method comprising:
routing ink from a sealed collapsible bag to a vented ink tank; and
routing ink from said vented ink tank to a printhead cartridge.

19. The method of claim 18, further including monitoring the ink level in the intermediate tank with a fluid level sensor.

20. The method of claim 18, wherein the act of routing ink from the sealed collapsible bag to the vented tank comprises inserting a hollow needle through a septum in the collapsible bag.

21. The method of claim 18, further comprising replacing the collapsible bag when the collapsible bag is substantially empty of ink by removing the hollow needle from the septum in the substantially empty collapsible bag and inserting the needle through a septum in a full collapsible bag such that printer operations are not suspended.

22. The method of claim 18, wherein the ink is caused to flow from the collapsible bag to the intermediate tank by the force of gravity.

23. An ink delivery system for supplying ink to an ink jet printer such that printer operations need not be suspended during replenishment of an ink supply, the ink delivery system comprising:
a replaceable ink reservoir;
a printhead cartridge;
means coupled between said replaceable ink reservoir and said ink jet cartridge for holding a vented reservoir of ink; and
means for routing ink from said replaceable ink reservoir to said printhead cartridge.
